(19) United States
(12) Patent Application Publication
(10) Pub. No.: US 2022/0120371 A1
(43) Pub. Date: Apr. 21, 2022

(54) UNIVERSAL PIPE FITTING WITH CLEANING

(71) Applicant: Dennis M. Delany, Lancaster, PA (US)

(72) Inventor: Dennis M. Delany, Lancaster, PA (US)

(21) Appl. No.: 17/075,331

(22) Filed: Oct. 20, 2020

(51) Int. Cl. F16L 55/24; B08B 5/02; B08B 9/02; B08B 9/032

(52) U.S. Cl. CPC F16L 55/24; B08B 5/02; B08B 2209/032; B08B 9/0328; B08B 9/021

(57) ABSTRACT

A pipe fitting having a first end portion, a second end portion and a perforated portion extending between the first end portion and the second end portion. The perforated portion has an inner side wall and outer wall spaced from the inner side wall. A fluid receiving cavity extends between the inner side wall and the outer wall. The inner side wall defines a material flow passageway. Openings are provided in the inner side wall of the perforated portion. The openings have ends which open into the fluid receiving cavity. A port extends through the outer wall and into the fluid receiving cavity. In operation, fluid enters the port and flows through the fluid receiving cavity and through the openings into the material flow passageway to clear any material restrictions.

### FIELD OF THE INVENTION

The present invention relates to a universal pipe fitting with a cleaning function. In particular, the invention relates to a fitting or coupling through which pressurized air, water or other cleaning solution is provided to an interior diameter of the pipe to remove blockages or restrictions.

### BACKGROUND OF THE INVENTION

In many manufacturing process, materials, whether liquid or solid, must be delivered from a holding tank or hopper to processing equipment, such as a mixer. The materials is often delivered by means of pipes or conduits which allow the material to flow from the hopper to the processing equipment. However, over time, the pipes may develop blockages or restrictions at various points in the pipe. The blockages or restrictions can cause significant issues in the final product, particularly in applications in which each of the materials must be precisely controlled. Consequently, it is often required to remove the blockages or restrictions manually and periodically. This process time is consuming, inefficient, and costly.

It would, therefore, be beneficial to provide a pipe fitting which can be integrated into the pipe at locations in which the blockage or restriction occurs. It would also be beneficial to provide the pipe fittings with an automated process to remove the blockage or restriction without then need to use the inefficient and costly manual process.

### SUMMARY OF THE INVENTION

An embodiment is directed to a pipe fitting having a first end portion, a second end portion and a perforated portion extending between the first end portion and the second end portion. The perforated portion has an inner side wall and outer wall spaced from the inner side wall. A fluid receiving cavity extends between the inner side wall and the outer wall. The inner side wall defines a material flow passageway. Openings are provided in the inner side wall of the perforated portion. The openings have ends which open into the fluid receiving cavity. A port extends through the outer wall and into the fluid receiving cavity. In operation, fluid enters the port and flows through the fluid receiving cavity and through the openings into the material flow passageway to clear any material restrictions.

An embodiment is directed to a system for delivering material from a feeding device to a processing device. The system includes a feeding device, a processing device, and a conduit. The feeding device stores and feeds material to the conduit. The processing device receives and processes the material. The conduit delivers the material from the feeding device to the processing device. The conduit has a fitting for cleaning material build-up in the conduit which causes restrictions in the delivery of material. The fitting includes a first end portion, a second end portion and a perforated portion extending between the first end portion and the second end portion. The perforated portion has an inner side wall and outer wall spaced from the inner side wall. A fluid receiving cavity extends between the inner side wall and the outer wall. The inner side wall defines a material flow passageway. Openings are provided in the inner side wall of the perforated portion. The openings have ends which open into the fluid receiving cavity. A port extends through the outer wall and into the fluid receiving cavity. A fluid delivery mechanism delivers pressurized fluid to the port. Wherein the fluid enters the port and flows through the fluid receiving cavity and through the openings into the material flow passageway to clear any material restrictions.

An embodiment is directed to a method for delivering material from a feeding device to a processing device. The method includes: moving material from the feeding device to the processing device through a conduit, the conduit having a fitting provided thereon; providing a pressurized fluid to a port of the fitting; and opening the port allowing the pressurized fluid to move through the port, into a fluid receiving cavity of the fitting, through openings in a perforated portion of the fitting and into a material flow passageway. The pressurized fluid interacts with a restriction in the material flow passageway to break down the restriction and cause the material forming the restriction to freely flow into the processing device.

Other features and advantages of the present invention will be apparent from the following more detailed description of the illustrative embodiment, taken in conjunction with the accompanying drawings which illustrate, by way of example, the principles of the invention.

### BRIEF DESCRIPTION OF THE DRAWINGS

FIG. 1 is a diagrammatic view of an illustrative system in which the pipe fitting of the present invention is used.

FIG. 2 is a perspective view of an illustrative embodiment of the pipe fitting of the present invention.

FIG. 3 is a cross-sectional view of the pipe fitting, taken along line 3-3 of FIG. 2.

FIG. 4 is a cross-sectional view of the pipe fitting, taken along line 4-4 of FIG. 2, no blockage or restriction is present.

FIG. 5 is a cross-sectional view similar to that of FIG. 4, with an internal blockage or restriction, showing the movement a cleaning fluid in the pipe fitting.

FIG. 6 is a perspective view of a first alternate illustrative embodiment of the pipe fitting of the present invention.

FIG. 7 is a perspective view of a second alternate illustrative embodiment of the pipe fitting of the present invention.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

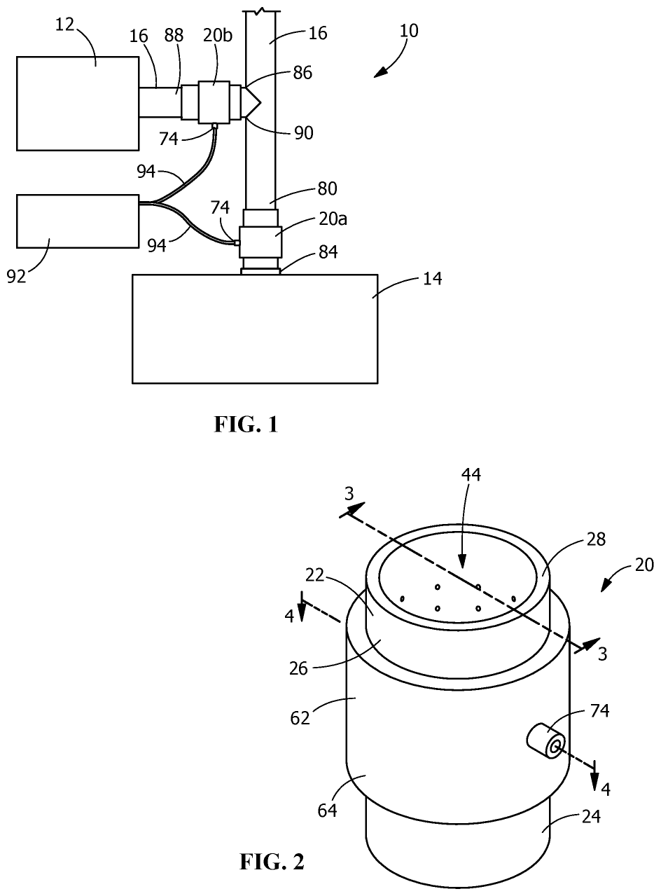

FIG. 1 shows an illustrative system 10 in which one or more pipe fittings 20 of the present invention may be used. The illustrative system 10 shown includes a material holding tank or hopper 12 and a processing device 14, such as, but not limited to, a mixer. One or more pipes or conduits 16 connect the hopper 12 to the processing device 14. The conduits may have one or more pipe fitting 20 integrated therein. Other embodiments of the illustrative system 10 can be used without departing from the scope of the invention.

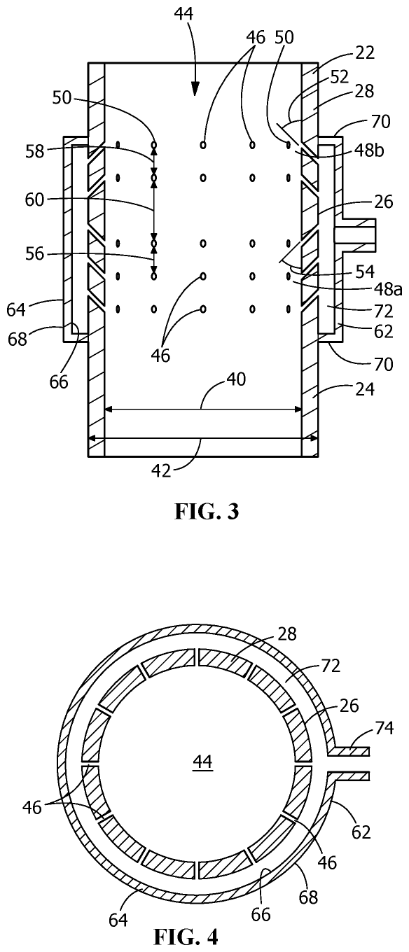

Referring to FIGS. 2 through 4, the illustrative pipe fitting 20 has a first end portion 22, a second end portion 24, and a perforated middle portion 26 which extends between the first end portion 22 and the second end portion 24. The pipe fitting 20 has a generally cylindrical configuration with a side wall 28 extending about the circumference of the pipe fitting 20. As shown in FIG. 3, the side wall 28 has an inner diameter 40 and an outer diameter 42. In the illustrative embodiment shown, the inner diameter 40 and the outer dimeter 42 of the side wall 28 is consistent across the first end portion 22, the second end portion 24 and the perforated portion 26. However, in other embodiments the inner diameter 40 and/or the outer diameter 42 of the side wall 28 may vary across the first end portion 22, the second end portion 24 and/or the perforated portion 26. The inner diameter 40 defines a material flow passageway 44.

The perforated portion 26 has multiple openings 46 which extend through the side wall 28 from the inner diameter 40 to the outer diameter 42. In the embodiment shown, the openings 46 are arranged in rows 48 which extend about the circumference of the side wall 28. Also, in the embodiment shown the openings 46 are positioned in columns 50. However, the arrangement of the openings 46 may vary without departing from the scope of the invention.

The openings 46 in each pipe fitting 20 are generally consistent. The preferred diameter of the openings 46 for a particular pipe fitting 20 is determined based on many variables, including, but not limited to, the size of the pipe fitting, the amount and the type of material which flows through the material flow passageway 44, and/or the type of cleaning fluid used.

As shown in FIG. 3, the openings 46 in rows 48a are angled downward at an angle 52, and the openings 46 in rows 48b are angled upward at an angle 54. The angles 52 and 54 may have the same measurement or may have different measurements. In the embodiment shown the perforated portion 26 has three rows 48a and two rows 48b, however other configurations may be used. While the angles 52, 54 shown are 45 degrees, other angles may be used, including, but not limited to, angles in the range of 30 degrees to 90 degrees.

Rows 48a of openings 46 are spaced apart a distance 56. Rows 48b of openings 46 are spaced apart a distance 58. In the embodiment shown distance 56 and distance 58 are equal, however, in other embodiments the distances 56, 58 may be different. In the embodiment shown, the distance 60 between a bottom row of the two rows 48b and a top row of the three rows 48a is greater than the distances 56, 58. However, in other embodiments, the distance 60 may be equal or less than one or more for the distances 56, 58.

In the illustrative embodiment shown, the openings 46 are spaced apart approximately 30 degrees from each other, thereby providing 12 openings 46 in each row 48 of openings 46. However, other spacing and other numbers of openings 46 may be provided in each row 48 without departing from the scope of the invention.

The perforated portion 26 has a fluid receiving flange or member 62 which extends from and integrally attached to the side wall 28 of the perforated portion 26. The fluid receiving member 62 has an outer wall 64 with an inner surface 66 and an outer surface 68. End walls 70 extend from the inner surface 66 of the outer wall 64 in a direction away from the outer surface 68. The end walls 70 engage are integrally attached to the side wall 28. The outer wall 64 is spaced from the side wall 28 to form a fluid receiving cavity 72 therebetween.

One or more ports 74 extend through the outer wall 64 and into the fluid receiving cavity 72. Each port 74 is configured to allow fluid, such as, but not limited to, air or water, to flow through the port 74 and into the fluid receiving cavity 72 when an appropriate source 92 is connected to the port 74 by flexible or rigid hoses 94 or the like (FIG. 1). In various illustrative embodiments, a check valve may be provided. The port 74 is configured to prevent the flow of fluids from the fluid receiving cavity 72 through the port 74. The port 74 may have threads to allow connection to a supply line (not shown). Alternative methods of securing the supply line to the port may also be used.

The fluid receiving cavity 72 extends about the entire circumference of the perforated portion 26. Each of the openings 46 has an end which opens into the fluid receiving cavity 72.

In the illustrative embodiment shown in FIG. 1, a first pipe fitting 20a has the first end portion 22 attached to an end 80 of the pipe or conduit 16 using known methods or devices of attachment, such as, but not limited to, adhesive, threads or a clamp. The second end portion 24 of the first pipe fitting 20a extends into a conduit receiving opening 84 of the processing device 14. The second end portion 24 is dimensioned to have a diameter less than a diameter of the opening 84, thereby allowing the second end portion 24 to be positioned in the opening 84 while allowing the second end portion 24 and the and the first pipe fitting 20a to move relative to the opening 84. A baffle or gasket (not shown) may be provided in the opening 84 to prevent the material from exiting through the opening 84 and to control the movement of the second end portion 24 of the first pipe fitting 20a relative to the opening 84. In the illustrative embodiment shown, the baffle or gasket is made from a compliant material, such as rubber.

In the illustrative embodiment shown in FIG. 1, a second pipe fitting 20b is positioned in a joint or bend 86 of the pipe or conduit 16. The second pipe fitting 20b has the first end portion 22 attached to a portion 88 of the pipe or conduit 16 using known methods or devices of attachment, such as, but not limited to, adhesive, threads or a clamp. The second end portion 24 of the second pipe fitting 20b is attached to another portion 90 of the pipe or conduit 16 using known methods or devices of attachment, such as, but not limited to, adhesive, threads or a clamp. Alternatively, second end portion 24 may be connected to a baffle or gasket which is connected to the portion 90 of the pipe or conduit 16.

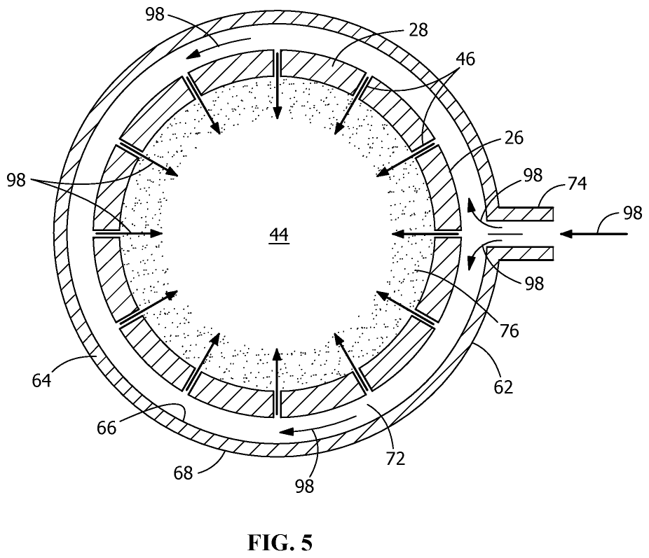

In use, material flows from the holding tank or hopper 12 through the pipes or conduits 16 and into the processing device 14. Material generally passes through the pipes or conduits 16 freely, as not blockage or restriction is provided in the interior of the pipes or conduits 16. However, in areas where the pipes bend or where there is a joint, such as such as represented by joint or bend 86, the rate of flow of material across the entire cross-section of the pipe or conduit 16 is not consistent, which may cause material to accumulate to form a blockage or restriction, similar to that shown as 76 in FIG. 5.

Similarly, in areas where the pipe end, such as represented by end 90, the rate of flow of material across the entire cross-section of the pipe or conduit 16 may not be consistent, which may cause material to accumulate to form a blockage or restriction, such as shown at 76. In addition, as the processing device 14 is operated, material may be forced back toward the end 90, causing material to accumulate as the end 90, as shown as 76 in FIG. 5.

The accumulation of material results in the pathway from the holding tank or hopper 12 to the processing device 14 being blocked or restricted. Any such restriction prevents the proper amount of material from being presented to the processing device 14, which can cause the processed material from having improper quantities of material, which in turn can cause the final product produced from the processed material to fail. It is, therefore, important to provide a device and method for keeping the pathway from the tank or hopper 12 to the processing device 14 free of significant accumulation of material. The use of the pipe fitting 20 of the present invention prevents the significant accumulation of material in the pipe or conduit 16.

As shown in FIG. 1, the pipe fitting 20 is positioned in one or more locations in the pipes or conduits 16, as was previously described. The one or more ports 74 are connected to a fluid supply device 94 by a hose or other delivery mechanism. The fluid 98 supplied by the fluid supply device 94 may be a liquid, such as water, or a gas such as air. The fluid supply device 94 may be a compressor, a pump or other known device which can deliver the fluid to the ports 74 and the pipe fitting 20 under pressure. The pressure may be varied depending upon many variable, including, but not limited to, the size of the system 10, the size of the pipes or conduits 16, the type of the material being delivered from the tank or hopper 12 to the processing device 14.

As periodic times or intervals, the ports 74 are opened to allow the pressurized fluid 98, as represented by the arrows 98 in FIG. 5, to move through the ports 74, into the fluid receiving cavity 72, through the openings 46 in the perforated portion 26 of the pipe fitting 20 and into the material flow passageway 44. As the fluid 98 is pressurized as it enters the ports 74, and as the size of the fluid receiving cavity 72 and the openings 46 are controlled, the fluid 98 entering the material flow passageway 44 interacts with any blockage or restriction 76 to break down the blockage or restriction 76 and cause the material forming the blockage or restriction 76 to freely flow into the processing device 14.

In order to prevent significant blockages or restrictions, and in order to ensure that all of the material from the tank or hopper 12 is moved to the processing device 14, the ports 74 may be opened one or more times as the material flows through the material flow passageway 44 to allow the liquid 98 to interact and clean any restrictions that may be forming. In so doing, any blockages or restrictions are prevented.

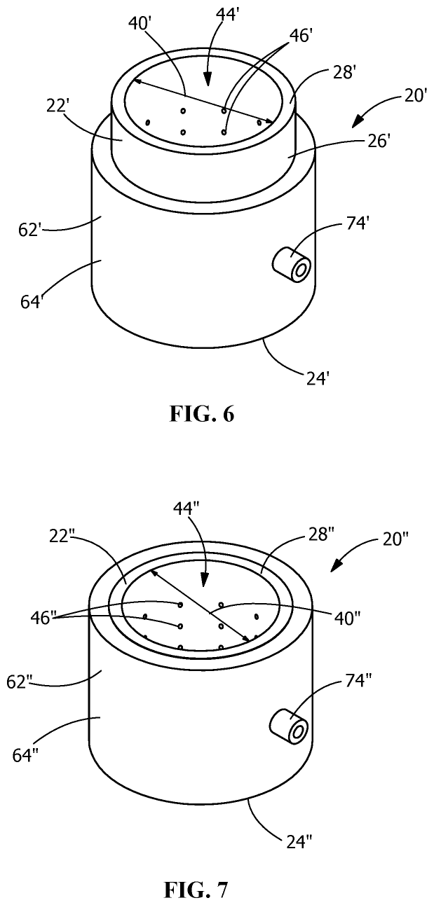

Referring to FIG. 6, a first alternate illustrative pipe fitting 20′ has a first end portion 22′, a second end portion 24′, and a perforated middle portion 26′ which extends between the first end portion 22′ and the second end portion 24′. The pipe fitting 20′ has a generally cylindrical configuration with a side wall 28′ extending about the circumference of the pipe fitting 20′. An inner diameter 40′ of the pipe fitting 20′ defines a material flow passageway 44′. The perforated portion 26′ has multiple openings 46′ which extend through the side wall 28′.

The perforated portion 26′ has a fluid receiving flange or member 62′ which extends from and integrally attached to the side wall 28′ of the perforated portion 26′. One or more ports 74′ extend from the fluid receiving flange or member 62′.

The operation of the first alternate illustrative pipe fitting 20′ is similar to that described above with respect to the pipe fitting 20.

Referring to FIG. 7, a second alternate illustrative pipe fitting 20″ has a first end portion 22″, a second end portion 24″, and a perforated middle portion 26″ which extends between the first end portion 22″ and the second end portion 24″. The pipe fitting 20″ has a generally cylindrical configuration with a side wall 28″ extending about the circumference of the pipe fitting 20″. An inner diameter 40″ of the pipe fitting 20″ defines a material flow passageway 44″. The perforated portion 26″ has multiple openings 46′ which extend through the side wall 28″.

The perforated portion 26″ has a fluid receiving flange or member 62″ which extends from and integrally attached to the side wall 28″ of the perforated portion 26″. One or more ports 74″ extend from the fluid receiving flange or member 62″.

The operation of the first alternate illustrative pipe fitting 20″ is similar to that described above with respect to the pipe fitting 20.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A pipe fitting comprising:
a first end portion, a second end portion and a perforated portion extending between the first end portion and the second end portion;
the perforated portion having an inner side wall and outer wall spaced from the inner side wall, a fluid receiving cavity extending between the inner side wall and the outer wall, the inner side wall defining a material flow passageway;
openings provided in the inner side wall of the perforated portion, the openings having ends which open into the fluid receiving cavity;
a port extending through the outer wall and into the fluid receiving cavity;
wherein fluid enters the port and flows through the fluid receiving cavity and through the openings into the material flow passageway to clear any material restrictions.

2. The pipe fitting as recited in claim 1, wherein the fluid is a liquid.

3. The pipe fitting as recited in claim 1, wherein the fluid is air.

4. The pipe fitting as recited in claim 1, wherein the openings are provided in multiple rows.

5. The pipe fitting as recited in claim 4, wherein the openings are provided in multiple columns.

6. The pipe fitting as recited in claim 1, wherein the openings extend through the inner side wall at angles which are not perpendicular to the plane of the inner side wall.

7. The pipe fitting as recited in claim 1, wherein the openings extend about the entire circumference of the inner side wall of the perforated portion.

8. The pipe fitting as recited in claim 1, wherein the port has a threaded portion.

9. The pipe fitting as recited in claim 1, wherein a second port extends through the outer wall and into the fluid receiving cavity.

10. The pipe fitting as recited in claim 1, wherein the first end portion is configured to be positioned and secured on an end of a pipe.

11. The pipe fitting as recited in claim 1, wherein the second end portion is configured to cooperate with a rubber baffle.

12. A system for delivering material from a feeding device to a processing device, the system comprising;
a feeding device for storing and feeding material;
a processing device for receiving material and processing the material;
a conduit for delivering the material from the feeding device to the processing device; the conduit having a fitting for cleaning material build-up in the conduit which causes restrictions in the delivery of material, the fitting comprising:
a first end portion, a second end portion and a perforated portion extending between the first end portion and the second end portion;
the perforated portion having an inner side wall and outer wall spaced from the inner side wall, a fluid receiving cavity extending between the inner side wall and the outer wall, the inner side wall defining a material flow passageway;
openings provided in the inner side wall of the perforated portion, the openings having ends which open into the fluid receiving cavity;
a port extending through the outer wall and into the fluid receiving cavity;
a fluid delivery mechanism for delivering pressurized fluid to the port;
wherein the fluid enters the port and flows through the fluid receiving cavity and through the openings into the material flow passageway to clear any material restrictions.

13. The system as recited in claim 12, wherein the fluid is water.

14. The system as recited in claim 12, wherein the fluid is air.

15. The system as recited in claim 12, wherein the openings are provided in multiple rows and in multiple columns.

16. The system as recited in claim 12, wherein the openings extend through the inner side wall at angles which are not perpendicular to the plane of the inner side wall.

17. The system as recited in claim 12, wherein the openings extend through the inner side wall at angles which are perpendicular to the plane of the inner side wall

18. The system as recited in claim 12, wherein the first end portion is configured to be positioned and secured on an end of the conduit.

19. The system as recited in claim 18, wherein the second end portion is configured to cooperate with a rubber baffle positioned in a conduit receiving opening of the processing device.

20. A method for delivering material from a feeding device to a processing device, the method comprising:
moving material from the feeding device to the processing device through a conduit, the conduit having a fitting provided thereon;
providing a pressurized fluid to a port of the fitting;
opening the port allowing the pressurized fluid to move through the port, into a fluid receiving cavity of the fitting, through openings in a perforated portion of the fitting and into a material flow passageway;
wherein the pressurized fluid interacts with a restriction in the material flow passageway to break down the restriction and cause the material forming the restriction to freely flow into the processing device.
